(19) United States
(12) Patent Application Publication
(10) Pub. No.: US 2025/0391291 A1
(43) Pub. Date: Dec. 25, 2025

(54) MULTI-LEVEL COMBINATION EXPRESSION METHOD AND SYSTEM FOR LOCATING AREA POSITIONS ON EARTHS SURFACE

(71) Applicant: Central South University, Changsha (CN)

(72) Inventor: Rongwu Luo, Changsha (CN)

(73) Assignee: Central South University, Changsha, HN (CN)

(21) Appl. No.: 19/312,299

(22) Filed: Aug. 28, 2025

(30) Foreign Application Priority Data
Sep. 10, 2024 (CN) 202411260889.7

(51) Int. Cl. G09B 29/10

(52) U.S. Cl. CPC G09B 29/10

(57) ABSTRACT

A multi-level combination expression method and system for locating area positions on Earth's surface are provided. The method comprises: dividing Earth's surface into a plurality of area blocks along longitude and latitude directions, to form a plurality of levels based on area of the plurality of area blocks from large to small; representing each level of the plurality of levels by two characters or words, with a first character or word representing a center point position of an area block of the plurality of area blocks in a longitude direction, and a second character or word representing a center point position of the area block in a latitude direction; and expressing a position of the area block on the Earth's surface by utilizing a multi-level combination method and a longitude latitude cross positioning method.

### CROSS-REFERENCE TO RELATED APPLICATION

The application claims priority to Chinese Patent Application No. 202411260889.7, filed on Sep. 10, 2024, which is hereby incorporated by reference in its entirety.

### TECHNICAL FIELD

The present disclosure relates to the technical field of geographic information, in particular to a multi-level combination expression method and system for locating area positions on Earth's surface.

### BACKGROUND ART

In scenarios such as logistics transportation and distribution, personnel pick-up and drop-off services, industrial and agricultural production, daily life, food delivery services, field rescue, fire fighting, emergency rescue, social governance (especially urban governance and rural governance), and land surveying and mapping, where accurate location information at different levels is required, accurate expression of location information is usually lengthy and prone to misunderstanding. In various work and life scenarios such as logistics transportation and distribution, personnel pick-up and drop-off services, industrial and agricultural production, daily life, food delivery services, field rescue, fire fighting, emergency rescue, social governance (especially urban governance and rural governance), and land surveying and mapping, people's requirements for the accuracy of location expression are different. At present, the “Three-Word Global Address System” (an application software called What3Words has been developed, hereinafter referred to as the “Three-Word System”) is widely used internationally. The “Three-Word System” divides the entire surface area of the Earth into regions of 3 meters×3 meters. Each region is represented by three unique words, and the scale of the words used is tens of thousands. When it comes to expressing a larger area, the “Three-Word System” faces the difficulty of being concise in expression, and sometimes the system may cause misunderstandings between the two adjacent areas involved due to the similar pronunciations of adjacent addresses. In addition, when further precision requirements at different levels are needed, it is difficult for this system to provide them concisely.

### SUMMARY

The purpose of the present disclosure is to overcome the aforementioned defects and problems existing in the prior art, and provide a multi-level combination expression method and system for locating area positions on Earth's surface, which is applicable to various working and living scenarios, has precise and concise expression, uses fewer character and word resources, and will not cause misunderstandings.

To achieve the above purpose, the technical solution of the present disclosure is: a multi-level combination expression method for locating area positions on Earth's surface, wherein the method includes:
dividing Earth's surface into multiple area blocks along longitude and latitude directions, to form multiple levels based on area of the multiple area blocks from large to small;
representing each level of the multiple levels by two characters or words, with a first character or word representing a center point position of an area block of the multiple area blocks in a longitude direction, and a second character or word representing a center point position of the area block in a latitude direction; and
expressing a position of the area block on the Earth's surface by utilizing a multi-level combination method and a longitude latitude cross positioning method.

The step of dividing Earth's surface into multiple area blocks along longitude and latitude directions, to form multiple levels based on area of the multiple area blocks from large to small includes:
dividing the Earth's surface into multiple region blocks each with an area of less than or equal to 10,000 meters×10,000 meters along the longitude and latitude directions, and the multiple region blocks constitute a first level;
dividing the multiple region blocks into multiple domain blocks arranged in order and according to rules each with an area of less than or equal to 1,000 meters×1,000 meters, and the multiple domain blocks constitute a second level;
diving the multiple region blocks into multiple large blocks arranged in order and according to rules each with an area of less than or equal to 100 meters×100 meters, and the multiple large blocks constitute a third level;
dividing the multiple region blocks into multiple middle blocks arranged in order and according to rules each with an area of less than or equal to 10 meters×10 meters, and the multiple middle blocks constitute a fourth level;
dividing the multiple region blocks into multiple small blocks arranged in order and according to rules each with an area of less than or equal to 2 meters×2 meters, and the multiple small blocks constitute a fifth level.
dividing the multiple small blocks into multiple secondary small blocks arranged in order and according to rules each with an area of less than or equal to 0.1 meters×0.1 meters, and the multiple secondary small blocks constitute a sixth level;
dividing the multiple small blocks into multiple tertiary small blocks arranged in order and according to rules each with an area of less than or equal to 0.01 meters×0.01 meters, and the multiple tertiary small blocks constitute a seventh level; and
dividing the multiple small blocks into multiple smallest blocks arranged in order and according to rules each with an area of less than or equal to 0.001 meters×0.001 meters, and the multiple smallest blocks constitute an eighth level.

The step of representing each level of the multiple levels by two characters or words, with a first character or word representing a center point position of an area block of the multiple area blocks in a longitude direction, and a second character or word representing a center point position of the area block in a latitude direction includes:
expressing the first level by two characters of Character Set 1, which is composed of at least 2,300 non-repetitive characters;
expressing the second level by two characters of Character Set 2, which is composed of at least 10 non-repetitive characters that do not belong to the Character Set 1;
expressing the third level by two characters of Character Set 4, which is composed of at least 100 non-repetitive characters that do not belong to Character Set 3, and the Character Set 3 is composed of the Character Set 1 and the Character Set 2;
expressing the fourth level by two characters of Character Set 6, which is composed of at least 1,000 non-repetitive characters that do not belong to Character Set 5, and the Character Set 5 is composed of the Character Set 3 and the Character Set 4;
expressing the fifth level by two characters of Character Set 8 or two words of Word Set 1, wherein the Character Set 8 is composed of at least 5,000 non-repetitive characters that do not belong to Character Set 7, and the Character Set 7 is composed of Character Set 5 and Character Set 6; wherein Word Set 1 is composed of at least 5,000 non-repetitive words;
expressing the sixth level by two characters of Character Set 10, which is composed of at least 20 non-repetitive characters that do not belong to Character Set 9, and the Character Set 9 is composed of the Character Set 7 and the Character Set 8;
expressing the seventh level by two characters of Character Set 12, which is composed of at least 200 non-repetitive characters that do not belong to Character Set 11, and the Character Set 11 is composed of the Character Set 9 and the Character Set 10; and
expressing the eighth level by two characters of Character Set 14 or two words of Word Set 2, wherein Character Set 14 is composed of at least 2,000 non-repetitive characters that do not belong to the Character Set 13, and the Character Set 13 is composed of the Character Set 11 and the Character Set 12; and the Word Set 2 is composed of at least 2,000 non-repetitive words that do not belong to the Word Set 1.

A character of the two characters is a Chinese character, a letter, a number, a combination of a letter and a number, a combination of two letters, a combination of two numbers, or a monosyllabic spelling structure in English or other languages.

A word of the two words is a structure of two Chinese characters, or a spelling structure of Chinese, English or other languages pronounced as two syllables.

The step of expressing a position of the area block on the Earth's surface by utilizing a multi-level combination method and a longitude latitude cross positioning method includes:
expressing by utilizing a combination of the first level and one of the second to fifth levels, and an expression format of which is: expressing a first character of longitude by the first level and expressing the first character of longitude by one of the second to fourth levels, and expressing a second character of latitude by the first level and expressing the second character of latitude by one of the second to fourth levels; or expressing the first character of longitude by the first level and expressing the first character or a first word of longitude by the fifth level, and expressing the second character of latitude by the first level and expressing the second character or a second word of latitude by the fifth level;
or expressing by utilizing a combination of the first level, the fifth level, and one of the sixth to eighth levels, and an expression format of which is: expressing the first character of longitude by the first level and expressing the first character or the first word of longitude by the fifth level and expressing the first character of longitude by one of the sixth to seventh levels, and expressing the second character of latitude by the first level and expressing the second character or the second word of latitude by the fifth level and expressing the second character of latitude by one of the sixth to seventh levels; or expressing the first character of longitude by the first level and expressing the first character or the first word of longitude by the fifth level and expressing the first character or the first word of longitude by the eighth level, or expressing the second character of latitude by the first level and expressing the second character or the second word of latitude by the fifth level and expressing the second character or the second word of latitude by the eighth level.

A multi-level combination expression system for locating area positions on Earth's surface is also provided, the system is applied to the aforementioned method and includes:
multiple level constructing modules, configured to divide Earth's surface into multiple area blocks along longitude and latitude directions, to form multiple levels based on area of the multiple area blocks from large to small;
a level expression setting module, configured to represent each level of the multiple levels by two characters or words, with a first character or word representing a center point position of an area block of the multiple area blocks in a longitude direction, and a second character or word representing a center point position of the area block in a latitude direction; and
an area positions expressing module, configured to express a position of the area block on the Earth's surface by utilizing a multi-level combination method and a longitude latitude cross positioning method.

A multi-level combination expression device for locating area positions on Earth's surface is further provided, and the device includes: a memory and a processor;
the memory is configured to store computer program codes and transmit the computer program codes to the processor; and
the processor is configured to execute instructions of the computer program codes to execute the aforementioned method.

A computer-readable storage medium is further provided, which is stored with computer programs, when executed by a processor, the computer programs implement the aforementioned method.

Compared with the existing technology, the beneficial effects of the present disclosure are as follows.

In the multi-level combination expression method and system for locating area positions on Earth's surface of the present disclosure, a two-level combination expression is adopted during expressing the most commonly used scenarios (the accuracy requirements for position expression are 1,000 meters×1,000 meters, 100 meters×100 meters, 10 meters×10 meters or 2 meters×2 meters). A three-level combination expression is adopted during expressing special scenarios (the accuracy requirements for position expression are 0.1 meters×0.1 meters, 0.01 meters×0.01 meters, or 0.001 meters×0.001 meters). The present disclosure is precise and concise in expression, uses less character and word resources, and will not cause misunderstandings. Moreover, the present disclosure can provide services of different levels of Earth's surface positions expression according to the needs of different work and life scenarios.

### BRIEF DESCRIPTION OF THE DRAWINGS

FIG. 1 is a flowchart of a multi-level combination expression method for locating area positions on Earth's surface of the present disclosure.

FIG. 2 is a structural block diagram of a multi-level combination expression system for locating area positions on Earth's surface of the present disclosure.

FIG. 3 is a structural block diagram of a multi-level combination expression device for locating area positions on Earth's surface of the present disclosure.

### DETAILED DESCRIPTION OF THE EMBODIMENTS

The following provides a further detailed description of the present disclosure in combination with the specific embodiments and the brief description of the drawings.

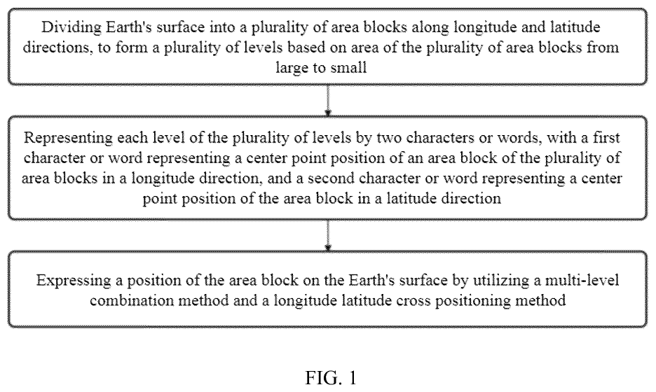

As shown in FIG. 1, a multi-level combination expression method for locating area positions on Earth's surface is provided. The method includes steps S1 to S3.

In S1, Earth's surface is divided into multiple area blocks along longitude and latitude directions, to form multiple levels based on area of the multiple area blocks from large to small, which includes following steps.

The Earth's surface is divided into multiple region blocks each with an area of less than or equal to 10,000 meters×10,000 meters along the longitude and latitude directions, and the multiple region blocks constitute a first level.

As the Earth's surface area is approximately 510 million square kilometers, the number of region blocks that are less than or equal to 10,000 meters ×10,000 meters is about 5,100,000. A region block with an area of 10,000 meters×10,000 meters is called to be a standard region block. Region block with an area of less than 10,000 meters ×10,000 meters is called to be a non-standard region block. Each non-standard region block may be embedded in a standard region block. Among non-standard region blocks, those with a maximum length of 10,000 meters in the latitude direction and a minimum length greater than 0 meter, and a maximum length of 10,000 meters in the longitude direction, are called to be adjustment region blocks. Other non-standard region blocks are called to be spliced region blocks. For each non-standard region block, it is mapped to a standard region block. When the position information of subsequent levels in the non-standard region block is expressed, the position information is given by the mapped standard region block.

The multiple region blocks are divided into multiple domain blocks arranged in order and according to rules each with an area of less than or equal to 1,000 meters×1,000 meters, and the multiple domain blocks constitute a second level.

The multiple region blocks are divided into multiple large blocks arranged in order and according to rules each with an area of less than or equal to 100 meters×100 meters, and the multiple large blocks constitute a third level.

The multiple region blocks are divided into multiple middle blocks arranged in order and according to rules each with an area of less than or equal to 10 meters×10 meters, and the multiple middle blocks constitute a fourth level.

The multiple region blocks are divided into multiple small blocks arranged in order and according to rules each with an area of less than or equal to 2 meters×2 meters, and the multiple of small blocks constitute a fifth level.

The dimensional accuracy of the fifth level can be set to be other values, such as 1 meter, 3 meters or 4 meters, and etc. The “Three-Word System” adopts a dimensional accuracy of 3 meters. In the present disclosure, the dimensional accuracy used in the fifth level is 2 meters, mainly considering that it can already represent the relationship between different lanes and parking spaces, and this leads to a more reasonable data scale. While 3 meters is larger than the width of a parking space for a small car, and 1 meter will multiply the scale of data, characters or words in the fifth level.

The multiple small blocks are divided into multiple secondary small blocks arranged in order and according to rules each with an area of less than or equal to 0.1 meters×0.1 meters, and the multiple secondary small blocks constitute a sixth level.

The multiple small blocks are divided into multiple tertiary small blocks arranged in order and according to rules each with an area of less than or equal to 0.01 meters×0.01 meters, and the multiple tertiary small blocks constitute a seventh level.

The multiple small blocks are divided into multiple smallest blocks arranged in order and according to rules each with an area of less than or equal to 0.001 meters×0.001 meters, and the multiple smallest blocks constitute an eighth level.

Instructions on region block area setting, hierarchical relationship setting, and region block splicing are as follows.

For the region block area setting, the most suitable choice for the present disclosure is a region block with an area of no larger than 10,000 meters×10,000 meters. The most common scenario of the present disclosure is in the field of transportation, including freight transport and passenger transport. Both parties in contact often face such a need: to determine a unique location as simply, without misunderstanding and precisely as possible. This kind of division can achieve such an effect. Due to this division, during determining region blocks, the required number of characters is approximately 2,300 (2,300×2,300=5,290,000), that is, in the expression of the first level, about 2,300 characters can represent the entire area of the Earth's surface. If other sizes are adopted, such as a region block with an area of 5,000 meters×5,000 meters, approximately 4,600 characters will be required. When all these characters are in Chinese characters, the probability of rare characters appearing in the character set is relatively high, and there will be more repeated characters. If a region block with an area of 20,000 meters×20,000 meters is adopted, although the number of characters required in the expression of the first level is relatively small (about 1,150 characters), the number of characters or words needed will reach 10,000 when a region block with an area of 2 meters×2 meters obtained from the fifth level. Correspondingly, when a region block with an area of 10,000 meters×10,000 meters is adopted, the number of characters or words required in the fifth level is only 5,000. In addition, the built-up area of medium and small-sized cities is usually within 100 square kilometers.

The present disclosure sets up eight levels, ranging from the first level with the largest area of 10,000 meters×10,000 meters to the eighth level with the smallest area of 0.001 meters×0.001 meters. Basically, it is constructed in accordance with the idea that “one decimal order of magnitude corresponds to one level”. That is, the “tenfold relationship” is basically adopted to construct between two adjacent levels (the same is true from the first level to the fourth level, and from the sixth level to the eighth level; the fourth level to the fifth level adopt a fivefold relationship; and the fifth level to the sixth level adopt a twentyfold relationship). Region block with area at different levels has certain actual or potential demands in different scenarios.

At the same longitude or latitude on the Earth's surface, since the circumference of the Earth is not an integer multiple of 10,000 meters, it is inevitable that “the longest length of a certain region block or certain region blocks in the longitude or latitude direction is less than 10,000 meters”. When the region blocks are set up, in order to facilitate subsequent use, it is necessary to ensure that the land area only has standard region blocks and adjusted region blocks as much as possible, and no spliced region blocks as much as possible. Spliced region blocks inevitably occur on the surface of the Antarctic continent, but this situation can basically be avoided on other land surfaces. The spliced region blocks are set as close as possible to the middle of large water surfaces and far away from the continents (such as oceans and seas).

In S2, each level of the multiple levels is represented by two characters or words, with a first character or word representing a center point position of an area block of the multiple area blocks in a longitude direction, and a second character or word representing a center point position of the area block in a latitude direction.

The first level is expressed by two characters of Character Set 1, which is composed of at least 2,300 non-repetitive characters.

Since 2,300 characters can be combined to form 2,300×2,300=5,290,000 combinations, theoretically, it can represent approximately 519 million square kilometers of the Earth's surface. Therefore, approximately 510 million square kilometers of the Earth's surface can be expressed by the Character Set 1. In the “List of Commonly Used Characters in Modern Chinese”, there are 2,500 commonly used characters and 1,000 less frequently used characters. Therefore, during expressing by utilizing Chinese characters, people will be more familiar with the corresponding characters.

The second level is expressed by two characters of Character Set 2, which is composed of at least 10 non-repetitive characters that do not belong to the Character Set 1.

The third level is expressed by two characters of Character Set 4, which is composed of at least 100 non-repetitive characters that do not belong to Character Set 3, and the Character Set 3 is composed of the Character Set 1 and the Character Set 2.

The fourth level is expressed by two characters of Character Set 6, which is composed of at least 1,000 non-repetitive characters that do not belong to Character Set 5, and the Character Set 5 is composed of the Character Set 3 and the Character Set 4.

The fifth level is expressed by two characters of Character Set 8 (Expression Mode P) or two words of Word Set 1 (Expression Mode Q), the Character Set 8 is composed of at least 5,000 non-repetitive characters that do not belong to Character Set 7, and the Character Set is composed of the Character Set 5 and Character Set 6; the Word Set 1 is composed of at least 5,000 non-repetitive words.

The sixth level is expressed by two characters of Character Set 10, which is composed of at least 20 non-repetitive characters that do not belong to Character Set 9, and the Character Set 9 is composed of the Character Set 7 and the Character Set 8.

The seventh level is expressed by two characters of Character Set 12, which is composed of at least 200 non-repetitive characters that do not belong to Character Set 11, and the Character Set 11 is composed of the Character Set 9 and the Character Set 10.

The eighth level is expressed by two characters of Character Set 14 (Expression Mode S) or two words of Word Set 2 (Expression Mode T), the Character Set 14 is composed of at least 2,000 non-repetitive characters that do not belong to the Character Set 13, and the Character Set 13 is composed of the Character Set 11 and the Character Set 12; and the Word Set 2 is composed of at least 2,000 non-repetitive words that do not belong to the Word Set 1. When conducting the expression at the eighth level, Expression Mode Por Q will be combined with Expression Mode S or T, resulting in expression mode such as Expression Mode PS, Expression Mode PT, Expression Mode QS, or Expression Mode QT.

A character of the two characters is a Chinese character, a letter (English letter or letter of other languages), a number, a combination of a letter and a number, a combination of two letters, a combination of two numbers, or a monosyllabic spelling structure in English or other languages. Letters are case-sensitive. However, when letters are used at the same level, only uppercase or only lowercase letters are used. When numbers are used as characters at the same level, a character can only be a one-digit number (or a combination of two one-digit numbers).

A word of the two words is a structure of two Chinese characters, or a spelling structure of Chinese, English or other languages pronounced as two syllables.

The principles that should be followed when naming each level separately are as follows. When region blocks at all levels (including region block, domain block, large block, middle block, small block, secondary small block, tertiary small block, and smallest block) are named, the principle that “within relatively adjacent areas, there are no identical or similar pronunciations for longitude and latitude” should be followed. This naming principle is called Naming Principle 1.

When a region block is named with the fifth level or a smallest block is named with the fifth level, if character naming is adopted, due to the large number of required characters, the number of homophones or rare characters will increase significantly, which may easily lead to pronunciation misunderstandings, errors, or difficulty in reading, and the Naming Principle 1 must be followed. If the Character Set 9 and the Character Set 13 are adopted and the Naming Principle 1 is followed, the technical difficulty is very high (for the Expression Mode P and the Expression Mode S). Therefore, a naming scheme using words (from the Word Set 1 and the Word Set 2) (i.e., the Expression Mode Q and the Expression Mode T) is proposed. When the Expression Mode Q or the Expression Mode Tis adopted, it is technically easy to follow the Naming Principle 1. And common characters or less common characters can be widely used to form words, the Expression Mode Q and the Expression Mode T are easier to recognize and read and avoid pronunciation misunderstandings. This is the reason why the Expression Mode Q and the Expression Mode T are proposed.

In S3, a position of the area block on the Earth's surface is expressed by utilizing a multi-level combination method and a longitude latitude cross positioning method.

In the most commonly used scenarios, a combination of the first level and one of the levels from the second level to the fifth level is adopted for expression. The expression format is as follows. A first character of longitude is expressed by the first level and the first character of longitude is expressed by one of the second to fourth levels, and a second character of latitude is expressed by the first level and the second character of latitude is expressed by one of the second to fourth levels; or the first character of longitude is expressed by the first level and the first character or a first word of longitude is expressed by the fifth level, and the second character of latitude is expressed by the first level and the second character or a second word of latitude is expressed by the fifth level.

In the specific scenarios (such as land surveying and mapping), a combination of the first level, the fifth level, and one of the sixth to eighth levels is adopted for expression. The expression format is as follows. The first character of longitude is expressed by the first level and the first character or the first word of longitude is expressed by the fifth level and the first character of longitude is expressed by one of the sixth to seventh levels, and the second character of latitude is expressed by the first level and the second character or the second word of latitude is expressed by the fifth level and the second character of latitude is expressed by one of the sixth to seventh levels; or the first character of longitude is expressed by the first level and the first character or the first word of longitude is expressed by the fifth level and the first character or the first word of longitude is expressed by the eighth level, or the second character of latitude is expressed by the first level and the second character or the second word of latitude is expressed by the fifth level and the second character or the second word of latitude is expressed by the eighth level.

The level sequence number of each level and the character sets and word sets used at each level constitute the Basic Data Set 1. The Earth's surface is divided into region blocks equal to or less than 100 square kilometers. The serial numbers and names of these region blocks, the data of the longitude and latitude center positions of each region block, as well as the longitude and latitude data of the endpoints of each region block (the number of endpoints of standard region blocks and adjusted region blocks is four, but the number of endpoints of spliced region blocks may be less than four, and in extreme cases, there may be no endpoints and only latitude data but no longitude data) are arranged in order to constitute the Basic Data Set 2. Within a region block and in the division from the second level to the fifth level, since it is the second division within the first level, the data within each region block with an area no larger than 10,000 meters×10,000 meters is structurally repetitive, and the naming rule is the same. The longitude direction data and the latitude direction data from the second level to the fifth level constitute the Basic Data Set 3. In the division from the sixth level to the eighth level, since it is the third division within the fifth level, the data within each small block with an area no larger than 2 meters×2 meters is structurally repetitive, and the naming rule is the same. The longitude direction data and the latitude direction data from the sixth level to the eighth level constitute the Basic Data Set 4.

The multi-level combination expression system for locating area positions on Earth's surface adopted by the present disclosure consists of eight levels, with scales of 10,000 meters×10,000 meters, 1,000 meters×1,000 meters, 100 meters×100 meters, 10 meters×10 meters, 2 meters×2 meters, 0.1 meters×0.1 meters, 0.01 meters×0.01 meters, and 0.001 meters×0.001 meters, which are respectively applicable to different demand scenarios, such as logistics transportation and distribution, personnel pick-up and drop-off services, industrial and agricultural production, daily life, food delivery services, field rescue, fire fighting, emergency rescue, social governance (especially urban governance and rural governance), and land surveying and mapping, and etc. Firstly, the Earth's surface is divided into larger areas for the first positioning (can also be called as the first level positioning). Then, on the basis of the first positioning, the area within a larger area is divided into smaller areas for the second positioning. In special scenarios (such as land surveying and mapping, and etc.), on the basis of the second positioning, the area within a smaller area is divided into even smaller areas for the third positioning. The expression method of “the first level and one of the second to fifth levels” is adopted in the most commonly used scenarios. In some specific scenarios (default scenario C) and when the simplified mode is adopted, it is also possible to directly adopt the expression method by a certain level alone. In special scenarios (such as land surveying and mapping, and etc.), the expression method of “the first level and the fifth level and one of the sixth to eighth levels” is adopted.

In the most commonly used scenarios, the complete expression method, the simplified expression method or the partially simplified expression method can be adopted. The complete expression method needs to express all the expressions at the first level (applicable to open scenario A). The simplified expression method omits all the expressions at the first level (applicable to default scenario C). The partially simplified expression method partially omits the expressions at the first level (applicable to semi-open scenario B). Each expression method has two expression modes of the Expression Mode P and the Expression Mode Q. When the complete expression method adopts the Expression Mode P, only four characters are required. When the complete expression method adopts the Expression Mode Q, only two characters and two words are required. In specific applications, when the simplified expression method adopts the Expression Mode P, only two characters are required. When the simplified expression method adopts the Expression Mode Q, only two words are required. When the partially simplified expression method adopts the Expression Mode P, only three characters are required. When the partially simplified expression method adopts the Expression Mode Q, only one character and two words are required. In special scenarios (such as land surveying and mapping, and etc.), when the complete expression method and the Expression Modes P and S are adopted, only six characters are required. When the complete expression method and the Expression Modes Q and T are adopted, two characters and four words are required. When the simplified expression method and the Expression Modes P and S are adopted, only four characters are required. When the simplified expression method and the Expression Modes Q and T are adopted, four words are required. When the partially simplified expression method and the Expression Modes P and S are adopted, only five characters are required. When the partially simplified expression method and the Expression Modes Q and T are adopted, one character and four words are required.

In order to accurately express the precise position of a certain small block with an area of 2 meters×2 meters on the Earth's surface, the method of combining the first level and the fifth level for expression can be adopted. Take the adoption of Expression Mode Q as an example. For example, the expression in a global location expression system of a small block with an area of 2 meters×2 meters. This small block belongs to the region block “xing chen”. That is, the position expression of this region block is composed in sequence of the first character “xing” expressing longitude and the second character “chen” expressing latitude (assuming that the Character Set 1 includes these two characters “xing” and “chen”). The position of this small block in the region block is composed in sequence of the first word “xiaocao” expressing longitude and the second word “dashu” expressing latitude (assuming that the Word Set 1 includes the words “xiaocao” and “dashu”). Then the expression of the small block with an area of 2 meters×2 meters in the Earth's surface position expression system is: “xing xiaocao, chen dashu”. In specific application, if the region block location has been determined (for example, for a delivery service that belongs to the “last kilometer”, and both parties in contact already know the approximate handover location, that is, the region block has been set to default (default scenario C), and the position error in both parties' cognition does not exceed one kilometer), then the simplified expression method can be adopted, that is, the location can be clearly expressed by utilizing the expression of the fifth level. That is, both parties only need to confirm “xiaocao, dashu” to accurately locate and smoothly complete the delivery and handover service. When both parties in contact have doubts about whether the region block is default and the location error is uncertain for several kilometers, the partially simplified expression (semi-open scenario B) can also be used. That is, both parties in contact only need to confirm “xing xiaocao, dashu” to accurately locate and smoothly complete the delivery and handover service.

In the most commonly used scenarios, when the complete expression method and the Expression Mode P are adopted, the exact position of an area of 2 meters×2 meters on the Earth's surface can be accurately expressed with just four characters, with a dimensional accuracy within 2 meters. If the region block has already been determined (default scenario C) and the Expression Mode P is adopted, only two characters are needed to accurately represent the exact position of an area of 2 meters×2 meters on the Earth's surface, with a dimensional accuracy within 2 meters. When the complete expression method and the Expression Mode Q are adopted, the exact position of an area of 2 meters×2 meters on the Earth's surface can be accurately expressed with “two characters and two words”, with a dimensional accuracy within 2 meters. If the region block has already been determined and when the simplified expression method and the Expression Mode Q are adopted, only two words are needed to accurately express the exact position of an area of 2 meters×2 meters on the Earth's surface, with a dimensional accuracy within 2 meters.

In special scenarios (such as land surveying and mapping, and etc.), when the complete expression method and the Expression Modes P and S are adopted, the exact position of an area of 0.001 meters×0.001 meters on the Earth's surface can be accurately expressed with just six characters, with a dimensional accuracy within 0.001 meters. When the complete expression method and the Expression Modes Q and T are adopted, the exact position of an area of 0.001 meters×0.001 meters on the Earth's surface can be accurately expressed with “two characters and four words”, with a dimensional accuracy within 0.001 meters.

### Embodiment 1

For delivery services: an urban area of a certain city is located in a region block where longitude is expressed as “xing” and latitude is expressed as “chen”. When the suppliers and demanders of the delivery service contact each other, if the delivery location is expressed as “xing xiaocao, chen dashu” in the Earth's surface location expression system, they can use the complete expression method to obtain the full name of the location expression “xing xiaocao, chen dashu” during contacting. When the region block has already been determined, they can use the simplified expression method to obtain the simplified position expression “xiaocao, dashu”. When the region block is roughly determined, they can use the partially simplified expression method to obtain the partially simplified positions expression “xing xiaocao, dashu”. The location is determined precisely, concisely and without any misunderstanding.

When an information seeker uses maps such as Gaode Map and Baidu Map, it is usually difficult for him/her to find the specific address under the traditional expression methods such as the expression method “a certain door of a certain building of a certain community of a certain street of a certain district”. Communication between the information seeker and the Maps is usually rather troublesome.

According to the data (from the English version of Wikipedia), in the area of London and when “Three-Word System” is adopted, approximately two out of every 24 addresses of London may be confused. In September 2022, the UK Ministry for Culture and the media used a “Three-Word System” to guide mourners to watch the Queen's funeral in London, four of the first five codes provided by the “Three-Word System” lead to incorrect locations.

### Embodiment 2

For fire fighting and flood control.

The scene 1 is fire fighting and extinguishing. Firefighters are preparing to head to the fire scene. If the current burning area of the fire scene is a zone with an area of 100 meters×100 meters and it is exactly located in a certain large block, the location of the fire scene can be expressed by “the first level and the third level”. For example, the block of the fire scene is “xing chen”, the third level is expressed by the Character Set 4, and the Character Set 4 is supposed to include elements “11,12”, then the expression of position of the fire scene might be: “xing 11, chen 12”.

Alternatively, if firefighters are preparing to head to a fire scene and the current burning area of the fire scene is a zone with an area of 10 meters×10 meters and it is exactly located in a certain middle block, the position of the fire scene can be expressed by “the first level and the fourth level”. For example, the region block of the fire scene is “xing chen”, the fourth level is expressed by the Character Set 6, and the Character Set 6 is supposed to include elements “AΔ, CV”, then the expression of position of the fire scene might be: “xing AΔ, chen CV”.

In traditional expression methods, a large amount of information is needed to be expressed (such as the expression of “a certain site of a certain company of a certain industrial park of a certain street of a certain district”). A considerable amount of information is also needed when the area of a fire scene is expressed.

The “Three-Word System” can express addresses, but it is usually rather difficult to concisely express larger areas.

The scene 2 is flood control and emergency rescue. At a certain position of a temporary embankment along the river of a certain area, a dangerous situation is occurred. The certain position is located in a rather remote and wild area, rescue supplies are needed to be delivered promptly.

It is very concise and precise to express by utilizing the expression “the first level and the fifth level” of the system of the present disclosure.

Amount of expression information (such as the expression “a certain specific location of a certain section of a certain village of a certain township”) is needed when the traditional expression methods are adopted. Due to there is no accurate address in the wild, a considerable amount of information is needed for expression and communication between the two parties involved is rather difficult.

### Embodiment 3

For social governance.

The scene 1 is maintenance of urban facilities. The scenario is that a manhole cover on the ground in a certain place of a certain city is damaged and needed to be replaced. A large amount of information is needed to express when the traditional expression methods are adopted, while the system of the present disclosure requires less information. In addition, it is necessary to find the relevant responsible grid workers. If the responsibility scope of the relevant responsible grid workers in a certain city is measured in units of 100 meters×100 meters, then the responsibility scope of the relevant responsible grid workers in the city can be displayed as “the first level and the third level”.

The scene 2 is agricultural pollutants in rural areas. Agricultural production pollutants in a certain area of a certain village may affect the drinking water source and need to be dealt with promptly. The exact location of the agricultural production pollutants needs to be reported. However, due to the remote location, traditional expression methods need to express a large amount of information and are difficult to express clearly. But the system of the present disclosure can express efficiently and accurately. In addition, the relevant responsible grid workers can also be found by utilizing the system of the present disclosure. If the responsibility scope of the relevant responsible grid workers in a certain rural area is measured in units of 1,000 meters×1,000 meters, the responsibility scope of the relevant responsible grid workers in a certain rural area can be displayed as “the first level and the second level”.

The scene 3 is that a vehicle is broke down unexpectedly on the expressway and is needed to be rescued. The rescued person may be in an unfamiliar environment, which causes it is difficult to express the location information of the rescued person effectively and clearly by utilizing the traditional expression methods, while the system of the present disclosure can express efficiently and clearly.

### Embodiment 4

For maritime rescue.

The scene 1 is that a maritime rescue operation is needed to be performed in a coastal city, and a small vessel being rescued is drifting in the wind and waves of a sea with an area of 100 meters×100 meters. The rescued vessel only needs four characters to express the combination position information of its first and third levels, and these four characters remain unchanged within a certain range of the vessel's drifting. Rescue workers can quickly locate and find the rescued vessel based on just four characters.

The scene 2 is that a maritime rescue operation is needed to be performed in a coastal city, and a large vessel being rescued (with a length exceeding 300 meters) is drifting in the wind and waves of a sea with an area of 1,000 meters×1,000 meters. The rescued vessel only needs four characters to express the combination position information of its first and second levels, and these four characters remain unchanged within a certain range of the vessel's drifting. Rescue workers can quickly locate and find the rescued vessel based on just four characters.

In traditional expression methods, longitude and latitude need to be used for expression, and a large amount of information is required to express the position of the vessel.

However, in the context of drifting, when the “Three-Word System” is adopted, it is very likely that the situation “just as one word is reported, its position has already changed, and thus the second word has also changed, making it impossible to effectively report the position” will occur. Unless three words are reported at one time. However, in tense and dynamic situations, this is rather difficult.

### Embodiment 5

For online car-hailing. A passenger tells the ride-hailing driver that “the location is xing xiaocao, chen dashu.” The ride-hailing driver can quickly and accurately find the location and pick up the passenger.

But in traditional expression methods, both parties need to know the position is which street, which place, which direction, or which corner of which intersection. These expressions are rather difficult for two strangers to understand each other.

### Embodiment 6

For land surveying and mapping and agricultural production.

The scene 1 is that the starting point along a certain direction in the national land surveying and mapping work is supposed to express, and the accuracy requirement of the surveying and mapping work is 0.001 meters. In the surveying and mapping work, when the starting point of a planar position in a certain direction is expressed, it is assumed that the Word Set 2 includes “dadi” and “jianghe”. And the Expression Modes Q and T are supposed to be adopted. The expression of this starting point might be: “xing xiaocao dadi, chen dashu jianghe”.

The scene 2 is that it is prepared to perform mechanized farming for a certain farmland. Positions of four control points in the farming area are needed to be expressed, and the position accuracy requirement is 0.01 meters.

The scene 3 is that it is prepared to spray pesticides on a certain farmland. Positions of four control points in the spraying operation area are needed to be expressed, and the position accuracy requirement is 0.1 meters.

But in traditional expression methods, when the longitude and latitude method is used for expression, a large amount of information is required. The “Three-Word System” also cannot express it concisely. However, the it can be expressed concisely by the present disclosure.

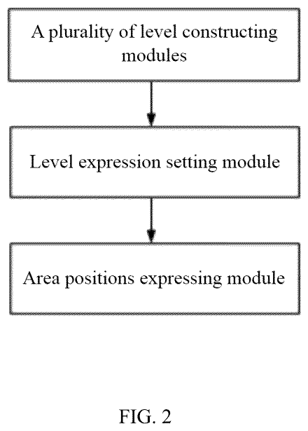

As shown in FIG. 2, a multi-level combination expression system for locating area positions on Earth's surface is provided, which is applied to the aforementioned multi-level combination expression method for locating area positions on Earth's surface. The system includes multiple level constructing modules, a level expression setting module, and an area positions expressing module.

The multiple level constructing modules each are configured to divide Earth's surface into multiple area blocks along longitude and latitude directions, to form multiple levels based on area of the multiple area blocks from large to small.

The level expression setting module is configured to represent each level of the multiple levels by two characters or words, with a first character or word representing a center point position of an area block of the multiple area blocks in a longitude direction, and a second character or word representing a center point position of the area block in a latitude direction.

The area positions expressing module is configured to express a position of the area block on the Earth's surface by utilizing a multi-level combination method and a longitude latitude cross positioning method.

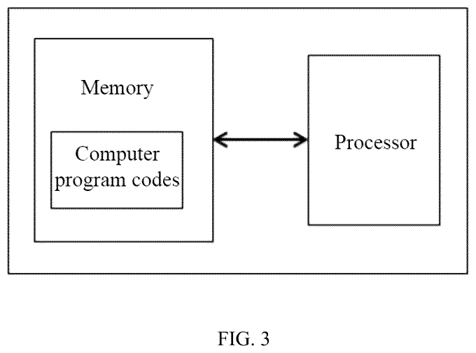

As shown in FIG. 3, a multi-level combination expression device for locating area positions on Earth's surface is further provided. The device includes a memory and a processor.

The memory is configured to store computer program codes and transmit the computer program codes to the processor.

The processor is configured to execute instructions of the computer program codes to execute the aforementioned multi-level combination expression method for locating area positions on Earth's surface.

A computer-readable storage medium is also provided by the present disclosure. The computer-readable storage medium is stored with computer programs. When the computer programs are executed by a processor, the computer programs implement the aforementioned multi-level combination expression method for locating area positions on Earth's surface.

Generally speaking, the computer instructions used to implement the method of the present disclosure can be carried by any combination of one or more computer-readable storage mediums. Non-temporary computer-readable storage medium may include any computer-readable medium except for the signal itself that is temporarily propagating.

The computer-readable storage medium, for example, can be, but is not limited to, electrical, magnetic, optical, electromagnetic, infrared, or semiconductor systems, devices or components, or any combination of the above. More specific examples (not exhaustive lists) of the computer-readable storage medium include following with one or more wires: electrical or portable computer disks, hard disks, random access memory (RAM), read-only memory (ROM), erasable programmable read-only memory (EKROM or flash memory), optical fibers, portable compact disk read-only memory (CD-ROM), optical storage devices, magnetic storage devices, or any suitable combination of the above. In the present disclosure, the computer-readable storage medium can be any tangible medium containing or storing a program or programs, which can be used by or used in combination with an instruction execution system, device or component.

The computer program codes for performing operations of the present disclosure can be written in one or more programming languages or their combinations. The programming languages include object-oriented programming languages such as Java, Smalltalk, and C++. The programming languages also include conventional procedural programming languages, such as “C” language or similar programming languages, especially Python language suitable for neural network computing and platform frameworks based on TensorFlow, PyTorch, and etc. The program codes can be fully executed on the user's computer, partially executed on the user's computer, executed as an independent software package, partially executed on the user's computer and partially executed on a remote computer, or fully executed on a remote computer or server. In cases involving the remote computer, the remote computer can be connected to the user's computer or to an external computer through any type of network, including a local area network (LAN) or a wide area network (WAN) (for example, the remote computer is connected to the user's computer or to an external computer through the Internet provided by an Internet service provider).

The aforementioned device and non-temporary computer-readable storage medium can be referred to the specific description of the beneficial effects of the multi-level combination expression method for locating area positions on Earth's surface, which will not be elaborated here.

Although the embodiments of the present disclosure have been shown and described above, it should be understood that the above embodiments are exemplary and cannot be interpreted as limitations of the present disclosure. Ordinary skills in the art can make changes, modifications, substitutions and variations to the above embodiments within the scope of the present disclosure.

What is claimed is:

1. A multi-level combination expression method for locating area positions on Earth's surface, comprising:
dividing Earth's surface into a plurality of area blocks along longitude and latitude directions, forming a plurality of levels based on area of the plurality of area blocks from large to small;
representing each level of the plurality of levels by two characters or words, with a first character or word representing a center point position of an area block of the plurality of area blocks in a longitude direction, and a second character or word representing a center point position of the area block in a latitude direction; and
expressing a position of the area block on the Earth's surface by utilizing a multi-level combination method and a longitude latitude cross positioning method.

2. The multi-level combination expression method for locating area positions on Earth's surface according to claim 1, wherein dividing Earth's surface into a plurality of area blocks along longitude and latitude directions, forming a plurality of levels based on area of the plurality of area blocks from large to small comprises:
dividing the Earth's surface into a plurality of region blocks each with an area of less than or equal to 10,000 meters×10,000 meters along the longitude and latitude directions, and the plurality of region blocks constitute a first level;
dividing the plurality of region blocks into a plurality of domain blocks arranged in order and according to rules each with an area of less than or equal to 1,000 meters×1,000 meters, and the plurality of domain blocks constitute a second level;
diving the plurality of region blocks into a plurality of large blocks arranged in order and according to rules each with an area of less than or equal to 100 meters×100 meters, and the plurality of large blocks constitute a third level;
dividing the plurality of region blocks into a plurality of middle blocks arranged in order and according to rules each with an area of less than or equal to 10 meters×10 meters, and the plurality of middle blocks constitute a fourth level; and
dividing the plurality of region blocks into a plurality of small blocks arranged in order and according to rules each with an area of less than or equal to 2 meters×2 meters, and the plurality of small blocks constitute a fifth level.

3. The multi-level combination expression method for locating area positions on Earth's surface according to claim 2, wherein
dividing the plurality of small blocks into a plurality of secondary small blocks arranged in order and according to rules each with an area of less than or equal to 0.1 meters×0.1 meters, and the plurality of secondary small blocks constitute a sixth level;
dividing the plurality of small blocks into a plurality of tertiary small blocks arranged in order and according to rules each with an area of less than or equal to 0.01 meters×0.01 meters, and the plurality of tertiary small blocks constitute a seventh level; and
dividing the plurality of small blocks into a plurality of smallest blocks arranged in order and according to rules each with an area of less than or equal to 0.001 meters×0.001 meters, and the plurality of smallest blocks constitute an eighth level.

4. The multi-level combination expression method for locating area positions on Earth's surface according to claim 3, wherein representing each level of the plurality of levels by two characters or words, with a first character or word representing a center point position of an area block of the plurality of area blocks in a longitude direction, and a second character or word representing a center point position of the area block in a latitude direction comprises:
expressing the first level by two characters of Character Set 1, which is composed of at least 2,300 non-repetitive characters;
expressing the second level by two characters of Character Set 2, which is composed of at least 10 non-repetitive characters that do not belong to the Character Set 1;
expressing the third level by two characters of Character Set 4, which is composed of at least 100 non-repetitive characters that do not belong to Character Set 3, and the Character Set 3 is composed of the Character Set 1 and the Character Set 2;
expressing the fourth level by two characters of Character Set 6, which is composed of at least 1,000 non-repetitive characters that do not belong to Character Set 5, and the Character Set 5 is composed of the Character Set 3 and the Character Set 4;
expressing the fifth level by two characters of Character Set 8 or two words of Word Set 1, the Character Set 8 is composed of at least 5,000 non-repetitive characters that do not belong to Character Set 7, and the Character Set 7 is composed of the Character Set 5 and Character Set 6; the Word Set 1 is composed of at least 5,000 non-repetitive words;
expressing the sixth level by two characters of Character Set 10, which is composed of at least 20 non-repetitive characters that do not belong to Character Set 9, and the Character Set 9 is composed of the Character Set 7 and the Character Set 8;
expressing the seventh level by two characters of Character Set 12, which is composed of at least 200 non-repetitive characters that do not belong to Character Set 11, and the Character Set 11 is composed of the Character Set 9 and the Character Set 10; and
expressing the eighth level by two characters of Character Set 14 or two words of Word Set 2, the Character Set 14 is composed of at least 2,000 non-repetitive characters that do not belong to the Character Set 13, and the Character Set 13 is composed of the Character Set 11 and the Character Set 12; and the Word Set 2 is composed of at least 2,000 non-repetitive words that do not belong to the Word Set 1.

5. The multi-level combination expression method for locating area positions on Earth's surface according to claim 4, wherein a character of the two characters is a Chinese character, a letter, a number, a combination of a letter and a number, a combination of two letters, a combination of two numbers, or a monosyllabic spelling structure in English or other languages.

6. The multi-level combination expression method for locating area positions on Earth's surface according to claim 4, wherein a word of the two words is a structure of two Chinese characters, or a spelling structure of Chinese, English or other languages pronounced as two syllables.

7. The multi-level combination expression method for locating area positions on Earth's surface according to claim 4, wherein expressing a position of the area block on the Earth's surface by utilizing a multi-level combination method and a longitude latitude cross positioning method comprises:
expressing by utilizing a combination of the first level and one of the second to fifth levels, and an expression format of which is: expressing a first character of longitude by the first level and expressing the first character of longitude by one of the second to fourth levels, and expressing a second character of latitude by the first level and expressing the second character of latitude by one of the second to fourth levels; or expressing the first character of longitude by the first level and expressing the first character or the a first word of longitude by the fifth level, and expressing the second character of latitude by the first level and expressing the second character or a second word of latitude by the fifth level;
or expressing by utilizing a combination of the first level, the fifth level, and one of the sixth to eighth levels, and an expression format of which is: expressing the first character of longitude by the first level and expressing the first character or the first word of longitude by the fifth level and expressing the first character of longitude by one of the sixth to seventh levels, and expressing the second character of latitude by the first level and expressing the second character or the second word of latitude by the fifth level and expressing the second character of latitude by one of the sixth to seventh levels; or expressing the first character of longitude by the first level and expressing the first character or the first word of longitude by the fifth level and expressing the first character or the first word of longitude by the eighth level, or expressing the second character of latitude by the first level and expressing the second character or the second word of latitude by the fifth level and expressing the second character or the second word of latitude by the eighth level.

8. A multi-level combination expression system for locating area positions on Earth's surface, applied to a multi-level combination expression method for locating area positions on Earth's surface, comprising:
a plurality of level constructing modules, configured to divide Earth's surface into a plurality of area blocks along longitude and latitude directions, to form a plurality of levels based on area of the plurality of area blocks from large to small;
a level expression setting module, configured to represent each level of the plurality of levels by two characters or words, with a first character or word representing a center point position of an area block of the plurality of area blocks in a longitude direction, and a second character or word representing a center point position of the area block in a latitude direction; and
an area positions expressing module, configured to express a position of the area block on the Earth's surface by utilizing a multi-level combination method and a longitude latitude cross positioning method;
wherein the multi-level combination expression method for locating area positions on Earth's surface comprises:
dividing Earth's surface into a plurality of area blocks along longitude and latitude directions, forming a plurality of levels based on area of the plurality of area blocks from large to small;
representing each level of the plurality of levels by two characters or words, with a first character or word representing a center point position of an area block of the plurality of area blocks in a longitude direction, and a second character or word representing a center point position of the area block in a latitude direction; and
expressing a position of the area block on the Earth's surface by utilizing a multi-level combination method and a longitude latitude cross positioning method.

9. The multi-level combination expression system for locating area positions on Earth's surface according to claim 8, wherein dividing Earth's surface into a plurality of area blocks along longitude and latitude directions, to form a plurality of levels based on area of the plurality of area blocks from large to small comprises:
dividing the Earth's surface into a plurality of region blocks each with an area of less than or equal to 10,000 meters×10,000 meters along the longitude and latitude directions, and the plurality of region blocks constitute a first level;
dividing the plurality of region blocks into a plurality of domain blocks arranged in order and according to rules each with an area of less than or equal to 1,000 meters×1,000 meters, and the plurality of domain blocks constitute a second level;
diving the plurality of region blocks into a plurality of large blocks arranged in order and according to rules each with an area of less than or equal to 100 meters×100 meters, and the plurality of large blocks constitute a third level;
dividing the plurality of region blocks into a plurality of middle blocks arranged in order and according to rules each with an area of less than or equal to 10 meters×10 meters, and the plurality of middle blocks constitute a fourth level; and
dividing the plurality of region blocks into a plurality of small blocks arranged in order and according to rules each with an area of less than or equal to 2 meters×2 meters, and the plurality of small blocks constitute a fifth level.

10. The multi-level combination expression system for locating area positions on Earth's surface according to claim 9, wherein
dividing the plurality of small blocks into a plurality of secondary small blocks arranged in order and according to rules each with an area of less than or equal to 0.1 meters×0.1 meters, and the plurality of secondary small blocks constitute a sixth level;
dividing the plurality of small blocks into a plurality of tertiary small blocks arranged in order and according to rules each with an area of less than or equal to 0.01 meters×0.01 meters, and the plurality of tertiary small blocks constitute a seventh level; and
dividing the plurality of small blocks into a plurality of smallest blocks arranged in order and according to rules each with an area of less than or equal to 0.001 meters×0.001 meters, and the plurality of smallest blocks constitute a eighth level.

11. The multi-level combination expression system for locating area positions on Earth's surface according to claim 10, wherein representing each level of the plurality of levels by two characters or words, with a first character or word representing a center point position of an area block of the plurality of area blocks in a longitude direction, and a second character or word representing a center point position of the area block in a latitude direction comprises:
expressing the first level by two characters of Character Set 1, which is composed of at least 2,300 non-repetitive characters;
expressing the second level by two characters of Character Set 2, which is composed of at least 10 non-repetitive characters that do not belong to the Character Set 1;
expressing the third level by two characters of Character Set 4, which is composed of at least 100 non-repetitive characters that do not belong to Character Set 3, and the Character Set 3 is composed of the Character Set 1 and the Character Set 2;
expressing the fourth level by two characters of Character Set 6, which is composed of at least 1,000 non-repetitive characters that do not belong to Character Set 5, and the Character Set 5 is composed of the Character Set 3 and the Character Set 4;
expressing the fifth level by two characters of Character Set 8 or two words of Word Set 1, the Character Set 8 is composed of at least 5,000 non-repetitive characters that do not belong to Character Set 7, and the Character Set 7 is composed of the Character Set 5 and Character Set 6; the Word Set 1 is composed of at least 5,000 non-repetitive words;
expressing the sixth level by two characters of Character Set 10, which is composed of at least 20 non-repetitive characters that do not belong to Character Set 9, and the Character Set 9 is composed of the Character Set 7 and the Character Set 8;
expressing the seventh level by two characters of Character Set 12, which is composed of at least 200 non-repetitive characters that do not belong to Character Set 11, and the Character Set 11 is composed of the Character Set 9 and the Character Set 10; and
expressing the eighth level by two characters of Character Set 14 or two words of Word Set 2, the Character Set 14 is composed of at least 2,000 non-repetitive characters that do not belong to the Character Set 13, and the Character Set 13 is composed of the Character Set 11 and the Character Set 12; and the Word Set 2 is composed of at least 2,000 non-repetitive words that do not belong to the Word Set 1.

12. The multi-level combination expression system for locating area positions on Earth's surface according to claim 11, wherein a character of the two characters is a Chinese character, a letter, a number, a combination of a letter and a number, a combination of two letters, a combination of two numbers, or a monosyllabic spelling structure in English or other languages.

13. The multi-level combination expression system for locating area positions on Earth's surface according to claim 11, wherein a word of the two words is a structure of two Chinese characters, or a spelling structure of Chinese, English or other languages pronounced as two syllables.

14. The multi-level combination expression system for locating area positions on Earth's surface according to claim 11, wherein expressing a position of the area block on the Earth's surface by utilizing a multi-level combination method and a longitude latitude cross positioning method comprises:
expressing by utilizing a combination of the first level and one of the second to fifth levels, and an expression format of which is: expressing a first character of longitude by the first level and expressing the first character of longitude by one of the second to fourth levels, and expressing a second character of latitude by the first level and expressing the second character of latitude by one of the second to fourth levels; or expressing the first character of longitude by the first level and expressing the first character or the a first word of longitude by the fifth level, and expressing the second character of latitude by the first level and expressing the second character or a second word of latitude by the fifth level;
or expressing by utilizing a combination of the first level, the fifth level, and one of the sixth to eighth levels, and an expression format of which is: expressing the first character of longitude by the first level and expressing the first character or the first word of longitude by the fifth level and expressing the first character of longitude by one of the sixth to seventh levels, and expressing the second character of latitude by the first level and expressing the second character or the second word of latitude by the fifth level and expressing the second character of latitude by one of the sixth to seventh levels; or expressing the first character of longitude by the first level and expressing the first character or the first word of longitude by the fifth level and expressing the first character or the first word of longitude by the eighth level, or expressing the second character of latitude by the first level and expressing the second character or the second word of latitude by the fifth level and expressing the second character or the second word of latitude by the eighth level.

15. A multi-level combination expression device for locating area positions on Earth's surface, comprising:
a memory and a processor;
the memory is configured to store computer program codes and transmit the computer program codes to the processor; and
the processor is configured to execute instructions of the computer program codes to execute a multi-level combination expression method for locating area positions on Earth's surface;.
wherein the multi-level combination expression method for locating area positions on Earth's surface comprises:
dividing Earth's surface into a plurality of area blocks along longitude and latitude directions, forming a plurality of levels based on area of the plurality of area blocks from large to small;
representing each level of the plurality of levels by two characters or words, with a first character or word representing a center point position of an area block of the plurality of area blocks in a longitude direction, and a second character or word representing a center point position of the area block in a latitude direction; and
expressing a position of the area block on the Earth's surface by utilizing a multi-level combination method and a longitude latitude cross positioning method.

16. The multi-level combination expression device for locating area positions on Earth's surface according to claim 15, wherein dividing Earth's surface into a plurality of area blocks along longitude and latitude directions, forming a plurality of levels based on area of the plurality of area blocks from large to small comprises:
dividing the Earth's surface into a plurality of region blocks each with an area of less than or equal to 10,000 meters×10,000 meters along the longitude and latitude directions, and the plurality of blocks constitute a first level;
dividing the plurality of region blocks into a plurality of domain blocks arranged in order and according to rules each with an area of less than or equal to 1,000 meters×1,000 meters, and the plurality of domain blocks constitute a second level;
diving the plurality of region blocks into a plurality of large blocks arranged in order and according to rules each with an area of less than or equal to 100 meters×100 meters, and the plurality of large blocks constitute a third level;
dividing the plurality of region blocks into a plurality of middle blocks arranged in order and according to rules each with an area of less than or equal to 10 meters×10 meters, and the plurality of middle blocks constitute a fourth level; and
dividing the plurality of region blocks into a plurality of small blocks arranged in order and according to rules each with an area of less than or equal to 2 meters×2 meters, and the plurality of small blocks constitute a fifth level.

17. The multi-level combination expression device for locating area positions on Earth's surface according to claim 16, wherein
dividing the plurality of small blocks into a plurality of secondary small blocks arranged in order and according to rules each with an area of less than or equal to 0.1 meters×0.1 meters, and the plurality of secondary small blocks constitute a sixth level;
dividing the plurality of small blocks into a plurality of tertiary small blocks arranged in order and according to rules each with an area of less than or equal to 0.01 meters×0.01 meters, and the plurality of tertiary small blocks constitute a seventh level; and
dividing the plurality of small blocks into a plurality of smallest blocks arranged in order and according to rules each with an area of less than or equal to 0.001 meters×0.001 meters, and the plurality of smallest blocks constitute a eighth level.

18. The multi-level combination expression device for locating area positions on Earth's surface according to claim 17, wherein representing each level of the plurality of levels by two characters or words, with a first character or word representing a center point position of an area block of the plurality of area blocks in a longitude direction, and a second character or word representing a center point position of the area block in a latitude direction comprises:
expressing the first level by two characters of Character Set 1, which is composed of at least 2,300 non-repetitive characters;
expressing the second level by two characters of Character Set 2, which is composed of at least 10non-repetitive characters that do not belong to the Character Set 1;
expressing the third level by two characters of Character Set 4, which is composed of at least 100 non-repetitive characters that do not belong to Character Set 3, and the Character Set 3 is composed of the Character Set 1 and the Character Set 2;
expressing the fourth level by two characters of Character Set 6, which is composed of at least 1,000 non-repetitive characters that do not belong to Character Set 5, and the Character Set 5 is composed of the Character Set 3and the Character Set 4;
expressing the fifth level by two characters of Character Set 8 or two words of Word Set 1, the Character Set 8 is composed of at least 5,000 non-repetitive characters that do not belong to Character Set 7, and the Character Set 7 is composed of the Character Set 5 and Character Set 6; the Word Set 1 is composed of at least 5,000 non-repetitive words;
expressing the sixth level by two characters of Character Set 10, which is composed of at least 20 non-repetitive characters that do not belong to Character Set 9, and the Character Set 9 is composed of the Character Set 7and the Character Set8;
expressing the seventh level by two characters of Character Set 12, which is composed of at least 200 non-repetitive characters that do not belong to Character Set 11, and the Character Set 11 is composed of the Character Set 9 and the Character Set 10; and
expressing the eighth level by two characters of Character Set 14 or two words of Word Set 2, the Character Set 14 is composed of at least 2,000 non-repetitive characters that do not belong to the Character Set 13, and the Character Set 13 is composed of the Character Set 11 and the Character Set 12; and the Word Set 2 is composed of at least 2,000 non-repetitive words that do not belong to the Word Set 1.

19. The multi-level combination expression device for locating area positions on Earth's surface according to claim 18, wherein a character of the two characters is a Chinese character, a letter, a number, a combination of a letter and a number, a combination of two letters, a combination of two numbers, or a monosyllabic spelling structure in English or other languages.

20. The multi-level combination expression device for locating area positions on Earth's surface according to claim 18, wherein a word of the two words is a structure of two Chinese characters, or a spelling structure of Chinese, English or other languages pronounced as two syllables.
